(19) United States
(12) Patent Application Publication
(10) Pub. No.: US 2007/0220057 A1
(43) Pub. Date: Sep. 20, 2007

(54) System and method for representing the operating status of an entity

(76) Inventors: Yaron Melman, Astoria, NY (US); Alexander Tal, Astoria, NY (US)

Correspondence Address: OSTROLENK FABER GERB & SOFFEN, 1180 AVENUE OF THE AMERICAS, NEW YORK, NY, 100368403, US

(21) Appl. No.: 11/335,240

(22) Filed: Jan. 19, 2006

(51) Int. Cl. G06F 17/30

(52) U.S. Cl. 707/200

(57) ABSTRACT

The invention relates to a centrally managed system that enables a party, such as a consumer or other individual, to have access to current and accurate information relating to an entity's actual hours of operation and/or current operating status. Instead of relying on published information relating to expected hours of operation, the present invention improves on the prior art by ensuring that information regarding an entity's operating status, for example, open or closed, in or out, etc., is current and accurate.

### FIELD OF THE INVENTION

The present invention relates generally to communication, and, more particularly, to a centrally managed process and system related to the production, reception and distribution of electronic information

### BACKGROUND OF THE INVENTION

Millions of people use the internet each day to locate information regarding goods and services. Very often, people use search engines, such as GOOGLE, YAHOO, EXCITE or the like, to uncover information regarding goods and services and providers thereof. In a typical scenario, people submit a search term that corresponds with the good or service, or the provider, and the search engine returns a list of selectable links, (i.e., hyperlinks) to web sites where information regarding the good or service is provided. Often, hyperlinks point to web sites of providers of the goods or services.

In other contexts, people enter a uniform resource locator (“URL”) of a web site that contains information regarding goods or services. For example, a user who enters a URL corresponding with a local hardware store in the address bar of a standard web browsing software will establish a communication session with a web server corresponding with the hardware store. The user can, thereafter, make selections, typically formatted as hyperlinks and various graphical screen controls, and, accordingly “navigate” to information regarding a particular good or service. Often, people use the internet to determine whether a particular establishment is open for business. Continuing with the above example, the local hardware store posts on its internet web site the usual hours of operation, often in a prominent way.

In addition to internet web sites, hours of operation are often provided in various other commercial media. For example, newspaper advertisements, billboard advertisements, radio and television advertisements, telephone yellow page advertisements, or the like often include respective hours of operation for a particular entity.

Much to the frustration of many consumers, often a business or entity is not open (or available), even though the business is advertised as being open. For example, the hardware store may advertise its hours of operation as 10:00 a.m.-6:00 p.m. A consumer, arrives at the store a few minutes before 6:00 p.m., but discovers the store closed. Although unusual, the store closed fifteen minutes early because of an unexpected condition.

Although the above-example relates to a retail establishment, there are countless examples of entities that maintain regular and/or irregular hours of operation. In many cases, expected hours of operation are listed and/or are available for review. Occasionally, the posted hours of operation do not coincide with actual hours of operation. Alternatively, a party seeking information relating to hours of operation cannot access that information conveniently. Moreover, even though hours of operation may be posted, the actual hours may vary.

### SUMMARY OF THE INVENTION

The present invention solves the above problems associated with determining whether an establishment or entity is actually available or open for business. Accordingly, the invention comprises a system and method for providing information representing operating statuses of a plurality of entities. In an embodiment of a system, the invention comprises a database on at least one information processor that stores respective electronic entity information representing a plurality of entities. The database further stores respective electronic operating status information that represents a respective operating status for each of the respective entities.

The invention further comprises a receiving module that is operable to receive over a communication network a plurality of identifiers representing the respective entities. The receiving module further receives a plurality of status indicators that represent changes in the respective entities' operating status, or can represent the entities' actual operating status.

The invention further comprises a tracking module that uses the status indicators to update the database with the electronic operating status information, and further to track current operating status for each of the plurality of entities. Further, the invention comprises a transmitting module that is operable to retrieve from the database the electronic operating status information and the electronic entity information. The transmitting module transmits identifiers representing the plurality of entities and respective electronic operating status information. The identifiers transmitted by the transmitting module may be the same or different than the identifiers received by the receiving module.

In various embodiment, the transmitting module is operable to transmit the identifiers (information) to a telephone directory assistance provider, an internet search engine, an internet web site, a voice mail system, a television advertiser, a radio advertiser, and/or a provider of electronic billboards.

In accordance with one embodiment, a business model is provided wherein a telephone directory assistance provider charges a first fee for providing a telephone number, and a second fee for providing operating status information without the telephone number, wherein the second fee is lower than the first fee.

Examples of the kinds of entities that include a retail goods provider, a retail service provider, a professional service provider, a recreational facility, a financial institution, a fitness center, a sports arena, a government/municipal office, a theater, a shopping mall, a school office, a library, and/or a restaurant.

In a preferred embodiment, the information processor further provides an internet web site, and the receiving module receives transmissions from one or more of a user terminal, a security system alarm panel, a fax machine, a login/logout device, and/or a telephone. Further, the receiving module comprises a telephone response system that is operable to receive telephone calls, and is further operable to receive touch-tone and/or voice commands.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in a preferred embodiment of the present invention;

FIG. 2 indicates the functional elements of a user terminal and/or information processor;

FIG. 3 is a block diagram that illustrates interaction between various devices, entities and requesting parties, in accordance with a preferred embodiment of the present invention;

FIG. 4 is a block diagram that illustrates an example networked arrangement of entities associated with the present invention; and

FIG. 5 is a block diagram that illustrates an embodiment of the present invention in which various sources of information interact with information processor and/or requesting party.

### DETAILED DESCRIPTION OF THE PREFERRED EMBODIMENTS

The present invention relates to a centrally managed system that enables a party, such as a consumer or other individual, to have access to current and accurate information relating to an entity's actual hours of operation and/or current operating status. Instead of relying on published information relating to expected hours of operation, the present invention improves on the prior art by ensuring that information regarding an entity's operating status, for example, open or closed, in or out, etc., is current and accurate.

Using the centrally managed system of the present invention, requests for information relating to an entity's operation or availability status is made available over a plurality of media, including (but not limited to) internet web sites, television, radio, telephone, billboards, and voice mail systems. The present invention further preferably provides business methods that can be implemented that generate revenue for one or more parties, as well as that save money simultaneously for one or more other parties. For example, parties seeking to generate revenue in accordance with the present invention can charge a fee for providing an entity's operating status information, and parties seeking to save money will not expend time and resources in the event that an entity is closed.

In a preferred embodiment of the present invention, a user interface is provided that enables an entity, such as a retailer, a government office, a university professor, or basically any entity that has particular hours of operation or availability, to identify whether the entity is open or otherwise available. In one embodiment, an internet web site is provided in which the entity submits a user name and password in order to engage in a secure communication session with the internet web site and the entity transmits information, for example, by selecting an icon that identifies the entity as open (or otherwise available) or closed (or otherwise unavailable). Once receiving information regarding the entity's status, an information processor makes the information available to various parties, such as, for example, an internet search engine, an electronic billboard, telephone service, internet web site, etc., that can provide the information to the requesting parties.

In another embodiment, an entity that is transmitting operating status information uses a telephone to update a database. For example, the entity calls a telephone number and an automated response device answers and instructs the entity to enter (or speak) his/her name, user id or other identifier, and to indicate that the operating status has changed. Alternatively, the entity's telephone number is automatically determined, for example, via Caller-ID, and the entity is automatically determined. Thus, by using a telephone, an entity can submit information regarding that entity's operating status.

In yet another embodiment, a device is provided to an entity which comprises a network communication module thereby enabling the device to transmit information over a communication network. In one embodiment, an entity presses a button or other control and the device automatically transmits an operating status indicator to a receiving device. The transmission is preferably very short, including, for example, an identifier of the entity and an indication that a change in operating status has occurred.

In yet another alternative embodiment, an entity's status information is transmitted when the entity uses a security alarm panel. For example, when a store owner arrives in the morning to open the store, the store owner keys in his alarm code to disable the security system. When the alarm is disabled, a signal is preferably transmitted to a receiving module that indicates a change in the operating status (for example, from closed to open). Thus, the present invention can use a security system panel to transmit operating status information.

In yet another alternative embodiment, a user speaks operating status information into a voice recognition device, and, thereafter, transmits the information to a receiving device. In a further alternative, an entity uses a facsimile machine to transmit operating status information. Thus, as will become clear to one skilled in the art, many different techniques and devices for transmitting operating status information from an entity to a receiving device are envisioned herein.

In addition to providing various ways for information regarding an entity's operating status to be sent to a central location, the present invention preferably provides a plurality of ways for operating status information to be disseminated to the public or particular parties who desire to know the operating status of an entity.

In a preferred embodiment of the present invention, information regarding the operating status of an entity is transmitted over the internet and displayed by a search engine. For example, a user submits a keyword search in a search engine for local hardware stores that sell a particular item. The search engine preferably returns a list of hyperlinks of various hardware stores that sell the item, and further includes text, an icon or other indication of the operating status of at least one hardware store in the list. In this way, users can determine at a glance whether a particular store is open at the time of the search.

In addition to displaying information via a search engine, other techniques are envisioned herein to receive and/or to disseminate operating status information. For example, an internet web site of an entity is preferably updated each time updates of operating status information are received from the entity. For example, a relatively small amount of programming code may be placed in an entity's web site that provides a connection to an information processor that regularly updates information related to the entity's operating status. This preferably enables the entity to transmit current operating status information to the information processor and/or enables the information processor to update the entity's web site with current operating status information. In this way, users of the internet who connect to the entity's web site are informed that the entity is currently available, and the entity itself can use its own web site to communicate operating status information to the information processor.

Although many of the embodiments and examples described herein relate to computing devices and the internet, the invention is not so limited. In one embodiment, operating status information is announced over a telephone whenever directory assistance provides a telephone number for a party requesting a telephone number (referred to herein, generally, as a “requesting user”), or when directory assistance connects a requesting party to an entity. In this embodiment, a directory assistance center, such as provided by a cellular telephone provider service or other telephone network provider, has a connection to an information processor that regularly updates information related to an entity's operating status.

Continuing with this embodiment, when a requesting user is provided a telephone number or is connected to an entity's telephone, the directory service provider automatically receives operating status information related to the entity and announces, preferably automatically, the operating status of the entity. In one embodiment, requesting parties may be provided with operating status information of an entity in lieu of receiving a telephone number or being connected to the entity by telephone. In this embodiment, requesting users may elect to receive only operating status information in lieu of a telephone number or telephone connection for a reduced rate. For example, a requesting user may be charged $1.00 by the directory assistance provider for a telephone number and/or a connection to an entity, and charged $0.25 for only operating status information. Of course, one skilled in the art will recognize that various business models are possible and envisioned herein that comprise operating status information, telephone numbers, telephone connections or combinations thereof.

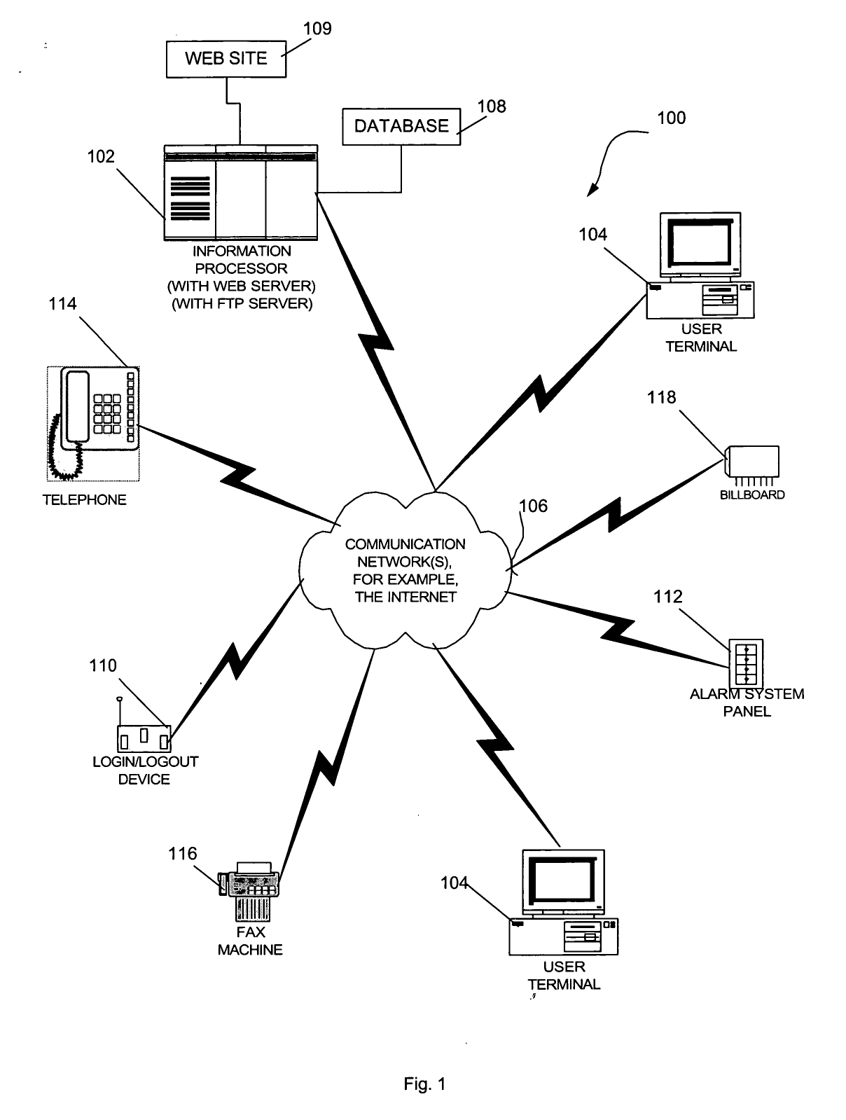

Referring to the drawings, in which like reference numerals refer to like elements, FIG. 1 shows an example hardware arrangement in a preferred embodiment of the present invention and referred to generally as system 100. In the embodiment shown in FIG. 1, system 100 comprises at least one information processor 102 configured to operate as an internet web server and/or a file transfer protocol (“FTP”) server, and that is operable to access and update a database 108. Database 108 is structured to maintain and/or manage operating status information regarding a plurality of entities that have various hours of operations.

Also, information processor preferably maintains web site 109, which provides an interface for entities to submit information to information processor regarding current operating status. For example, web site 109 includes graphical screen controls that enable a registered user to submit a user name and password, i.e., to log in., and thereafter to select a control, such as a button, to indicate a change in operating status. Thereafter, information processor 102 preferably updates database 108 and the change of operating status is noted and reflected in accordance with the teachings herein.

Information processor 102 preferably accesses communication network 106 and communicates with at least user terminals 104. Preferably, user terminals 104 and information processor 102 communicate via the known communications protocol, Transmission Control Protocol/Internet Protocol “TCP/IP.” In this way, content can be transmitted to and from the devices 102 and 104, and commands can be executed to enable the various functions described herein.

Information processor 102 and user terminals 104 are any devices that are capable of sending and receiving data across communication network 106, e.g., mainframe computers, mini computers, personal computers, laptop computers, a personal digital assistants (PDA) and internet access devices such as Web TV. In addition, information processor 102 and user terminals 104 are preferably equipped with a web browser, such as MICROSOFT INTERNET EXPLORER, NETSCAPE NAVIGATOR, MOZILLA FIRREFOX or the like. Thus, as envisioned herein, information processor 102 and/or user terminals 104 are devices that can communicate over a network and can be operated anywhere, including, for example, moving vehicles.

In addition to information processor and user terminals 104, which are depicted as computing devices, system 100 comprises a plurality of devices that send and/or receive information to/from information processor 102. For example, login/logout device 110 is operable to transmit at least a signal to information processor that represents that a change in an entity's operating status has occurred. Login/logout device 110 preferably comprises an interface, comprising one or more buttons, and a communication module that enables signal transmission over a communication network. In a preferred embodiment, when the signal is received, information processor updates database 108 to represent the change. For example, database 108 represents that a particular entity, such as a carpenter's business, is closed. When a signal is received from login/logout device 110, database 108 is updated to change the operating status information from closed to open. Alternatively, login/logout device 110 transmits actual operating status information (e.g., “open” or “closed”).

Another device that can be included in system 100 is alarm panel 112, such as typically used to turn on and off a building or residence security system. Many entities utilize security systems that comprise alarm panels and, typically by entering an identification code, enable or disable the security system. Preferably, alarm panel 112 is formatted such that when a security system is enabled or disabled, a signal is transmitted that directly or indirectly instructs information processor 102 to update an entity's respective operating status information in database 108. For example, when a retail goods provider enters his store in the morning, he enters his identification code into his security system's panel 112. When the code is entered to disable the security system, a signal is transmitted from alarm panel 112 that directly or indirectly instructs information processor 102 to update operating status information in database 108 from closed to open.

Other devices that can be included in system 100 are telephone 114 and facsimile machine 116. Entities that desire to report a change in operating status can use telephone 114 to instruct information processor 102 to update database 108. For example, an entity preferably places a call to an automated and interactive telephone response system and uses touch tone keys (or simply speaking) to transmit information regarding the change in operating status. In one embodiment, the present invention utilizes Caller-ID, as known in the art, such that the caller is identified automatically, thereby enabling a minimal amount of information to be transmitted. For example, the caller is identified automatically, and presses or speaks the number in order to transmit change in operating status information directly or indirectly to information processor 102. Alternatively, entities can use facsimile machine 116 to transmit a fax that instructs information processor 102 to update database 108 with respect to an entity's current operating status.

Yet another device illustrated in FIG. 1 is electronic billboard 118. In one. embodiment, billboard 118 preferably receives information from information processor 102 that enables billboard 118 to provide current operating status information to passers-by. For example, billboard 118 advertises a particular restaurant and reads, “Currently: OPEN.” In this way, billboard 118 can provide dynamically changing operating status information.

The nature of the present invention is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, MICROSOFT .NET, and a plurality of various web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user terminals 104 and information processor 102, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, the present invention preferably supports various suitable multi-media file types, including (but not limited to) JPEG, BMP, GIF, TIFF, MPEG, AVI, SWF, RAW or the like (as known to those skilled in the art).

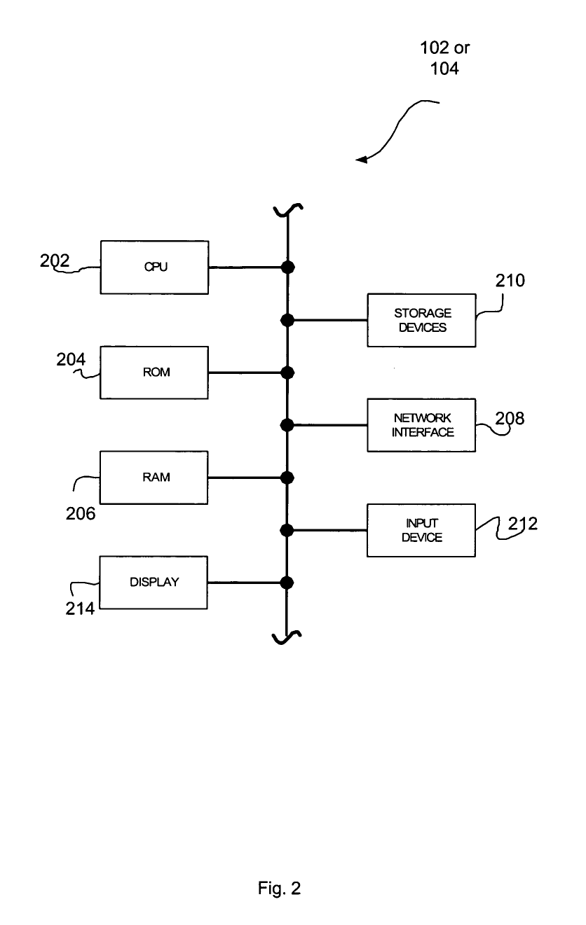

FIG. 2 illustrates the functional elements of user terminal 104 and/or information processor 102 and that include one or more central processing units (CPU) 202 used to execute software code and control the operation of user terminal 104 or information processor 102, read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code, databases and application data, one or more input devices 212 such as a keyboard, mouse, track ball, magnetic card reading device, bar code reading device, microphone or the like, and a display 214.

The various components of information processor 102 and/or user terminal 104 need not be physically contained within the same chassis or even located in a single location. For example, storage device 210 may be located at a site which is remote from the remaining elements of information processor 102 or user terminal 104, and may even be connected to CPU 202 across communication network 106 via network interface 208. Information processor 102 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user terminals 104. Information processor 102 is arranged with components, for example, those shown in FIG. 2, suitable for the expected operating environment of information processor 102. The CPU(s) 202, network interface(s) 208 and memory and storage devices are selected to ensure that capacities are arranged to accommodate expected demand.

As used herein, the term, “module” refers, generally, to one or more discrete components that contribute to the effectiveness of the present invention. Modules can operate or, alternatively, depend upon one or more other modules in order to function.

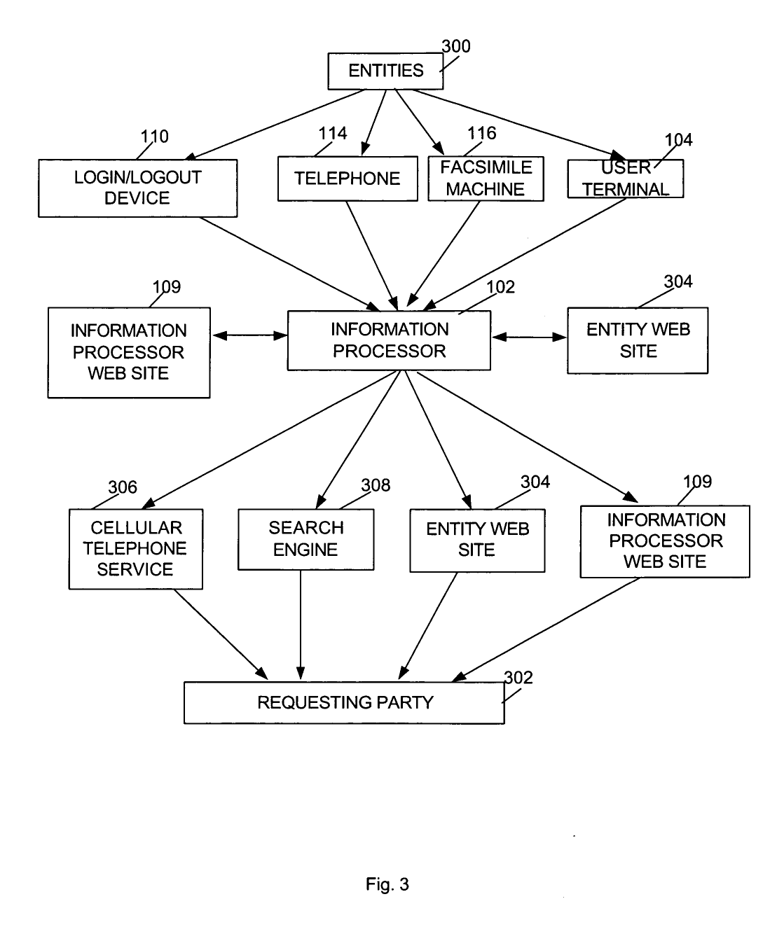

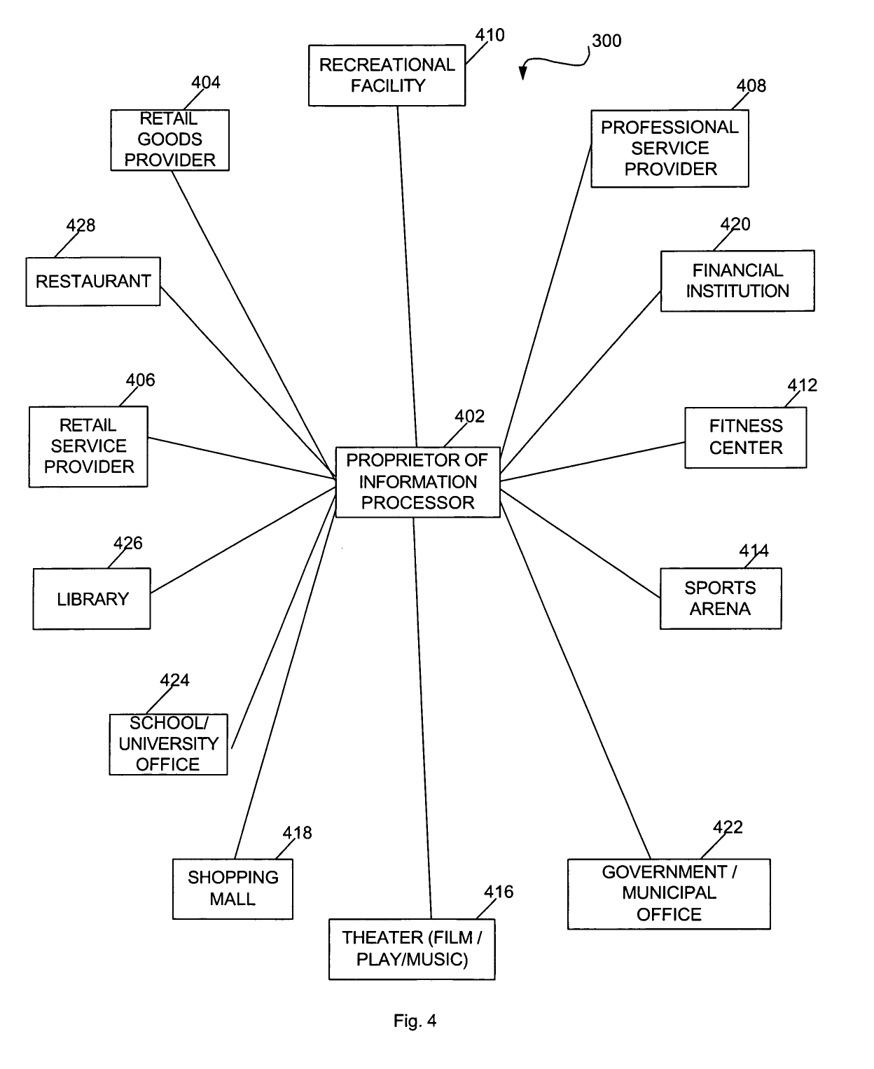

FIG. 3 is a block diagram that illustrates interactions between various devices, entities and requesting parties, in accordance with a preferred embodiment of the present invention. As shown in FIG. 3, entities 300 are parties that maintain hours of operation and/or availability. For example, entities 300 may be retailers, providers of various services, theaters, or the like. Various examples of entities 300 are provided in greater detail below with reference to FIG. 4.

Continuing with reference to FIG. 3, entities 300 communicate with information processor 102, for example via login/logout device 110, telephone 114, facsimile machine 114 and user terminal 104. Information processor 102 communicates with web site 109, which may be maintained by information processor 102, or, alternatively, by a separate internet web server that is under the control of a proprietor of information processor 102. Moreover, information processor 102 preferably communicates with web site 304 which is under the control of a respective entity 300. For example, a hardware store that uses the present invention has a web site 304 that is regularly updated by information processor 102 whenever a change in operating status is determined.

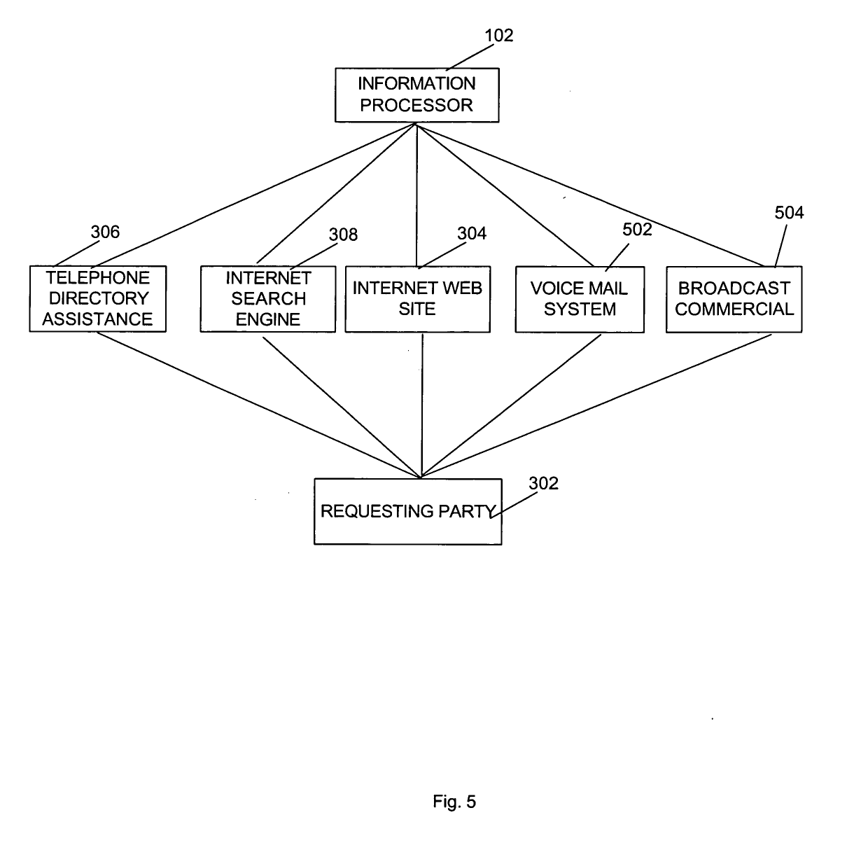

Information processor further communicates to requesting parties 302 operating status information of respective entities 300. For example, information processor 102 transmits information to cellular telephone service provider 306, search engine 308, entity's web site 304 and/or information processor web site 109. Thus, a requesting party 302 can visit web site 109 and/or web site 304 in order to determine the operating status of a particular entity. For example, web site 109 includes a text box control in which the requesting party 302 submits the name of a respective entity 300. In response, web site 109 displays information from database 108 that represents whether the entity 300 is open or closed. Various other examples are provided in greater detail below, with reference to FIG. 5.

It is to be understood that the devices and parties shown in FIG. 3 are illustrative, and that other parties, devices and mechanisms are equally applicable, as known in the art.

FIG. 4 is a block diagram that illustrates an example networked arrangement of entities 300 associated with the present invention. As noted with reference to FIGS. 1 and 2, the present invention is operable over one or more communication networks, such as the internet, a wide area networks, a local area network or the like. Thus, the present invention allows various parties to communicate information to each other that is useful or necessary to execute the teachings herein. One skilled in the art will recognize that the internet enables the convenient and rapid exchange of information, thereby enabling parties to transmit information.

Continuing with reference to FIG. 4, proprietor of information processor 102 preferably implements many of the teachings provided herein. For example, proprietor 402 maintains information processor 102, thereby providing operating status information related to one or more entities. Operating status information is preferably received by proprietor 402 in accordance with the teachings herein, and provided in various contexts to parties seeking operating status information. A non-exhaustive representation of entities that interact and provide operating status information to proprietor 402 is shown in FIG. 4 and described below.

Retail goods provider 404 comprises any provider of goods, notwithstanding the size of retail goods provider 404. Although operating hours of retail goods providers 404 are often posted in many places, such as telephone directories, newspaper advertisements, and internet web sites, occasionally actual operating status may be different for various reasons. For example, inclement weather, or other otherwise unexpected conditions can cause a retail goods provider 404 to deviate from otherwise ordinary hours of operation. In accordance with the teachings herein, parties seeking operating status information are notified whether a respective retail goods provider 404 is open for business.

In addition to retail goods providers 404, retail service providers 406 are parties that utilize the present invention in order to provide respective operating status to inquiring parties. Examples of retail service providers 406 include (but are not limited to) electricians, plumbers, carpenters, builders, contractors, or the like. It is believed by the inventors that the present invention is well-suited to retail goods providers 404 because such parties may maintain hours of operation that may fluctuate. For example, a plumber may anticipate being at a particular site for a period of time, but may remain at the site for considerably longer. Accordingly, the plumber may elect to rearrange his schedule and end his work day after leaving the site. In accordance with the teachings herein, the plumber contacts information processor 102 and the plumber's modified operating status information is available for parties seeking it.

In addition to retail service providers 406, professional service providers 408 preferably use the present invention to alert parties of current operating status information. For example, physicians and other members related to healthcare (e.g., chiropractors, physician assistants, physical therapists, extended care providers) lawyers, computer professionals, accountants, insurance professionals, or the like, may provide respective operating status information to information processor 102. In case of an unexpected condition, for example, inquiring parties can be informed via the present invention of the current operating status of the entity 408.

Continuing with reference to FIG. 4, another example entity that provides operating status information to proprietor 402 is a recreational facility 410. Examples of recreational facilities 410 include, but are not limited to, skating rinks, skiing facilities, swimming centers, arcades and games centers, or the like. Although many recreational facilities 410 maintain regular and reliable operating hours, occasionally actual operating status may be different for various reasons. For example, private parties, technological failures, poor weather (e.g., warm weather or lack of snow), or other otherwise unexpected conditions can cause a recreational facility 410 to deviate from otherwise ordinary hours of operation.

Other example entities shown in FIG. 4 include fitness center 412 (such as a health and/or racquet club), sports arena 414 (such as a coliseum or civic center), theater 416 (which may provide stage or screen performances of film/drama/music) and shopping mall 418, which may be an indoor mall, as known to those skilled in the art. It is believed by the inventors that these locations typically have well-maintained hours of operation, but occasionally depart from normal hours of operation for various reasons.

In addition to entities 404-428, other entities that provide operating status information to proprietor 402 include financial institution 420, government/municipal office 422, school/university office 424, library 426, and restaurant 428. Financial institution 320 may be a bank or other institution. Government/municipal office 422 may include, for example, a state department of motor vehicles, tax collector's office, or the like. School/university office 424 may regard a respective teacher's office hours, or various department office hours (financial aid, registrar's office, or the like). Library 426 may be a public library, a private library, a school (e.g., a university or high school) library, or the like. Restaurant 428 may be any establishment that serves food and/or beverages, and is open to private and/or public parties. Entities 420-428 may encounter circumstances that require a deviation from normally set hours of operation (or availability, such as in the case of a university professor) and the present invention can be used to receive operating status information, and to notify parties of any updates thereto.

Thus, as represented by the block diagram shown in FIG. 4, a plurality of types of entities utilize the present invention to transmit information regarding each entity's operating status. All of the information received by information processor 102 is preferably managed such that data integrity (i.e., maintaining each party's respective data) is not compromised.

FIG. 5 is a block diagram that illustrates an embodiment of the present invention in which various sources of information interact with information processor 102 and/or requesting party 302. For example, and as illustrated in FIG. 5, directory assistance provider 504 receives a request for directory information from requesting party 302 regarding a particular entity among the networked arrangement 300 of entities (FIG. 4). As noted above, directory assistance provider 504 preferably communicates with information processor 102 in order to receive updated information related to entities' operating status. When a requesting user requests directory information related to the particular entity, directory service provider 306 announces, preferably automatically, the operating status of the entity. In one embodiment, requesting parties 302 may be provided with operating status information of an entity 300, telephone and address information, or both.

Continuing with reference to FIG. 5, in response to a search (e.g., a keyword search) for a member of entities 300, internet search engine 308 preferably returns a list of hyperlinks to web sites regarding the entity 300, as well as text, an icon or other indication of the operating status of the entity. In this way, requesting party 302 can determine the operating status of a particular entity 300.

In addition, internet web site 304, which is typically provided by a respective entity 300, that provides current operating status. Preferably, internet web site 304 of an entity is preferably updated each time updates of operating status information are determined. For example, a relatively small amount of programming code is included in the entity's web site 304, which provides a connection to information processor 102 in order to receive updated information regarding the entity's operating status. For example, when an entity 300 notifies information processor 102 of a change in entity status, the entity's web site 304 is updated instantly to represent the change in the entity's operating status. In this way, visitors to the entity's web site receive current and up-to-the-minute information regarding an entity's operating status.

Another way requesting parties 302 are informed of an entity's 300 operating status is via a voice mail system 502, such as provided by telephone service providers. For example, when a consumer calls the telephone number of an entity 300, a voice mail system 502 initially answers the telephone and provides an announcement regarding the entity's operating status.

Other embodiments are provided in which users are provided information regarding an entity 300 various public media. For example, a television or radio broad commercial 504 is provided in which a commercial for a respective entity 300 is aired that describes the entity. Information processor 102 preferably provides operating status information to the party providing the commercial such that at some point during the commercial, an announcement regarding the entity's operating status is made. In this way, for example, a consumer can see and/or hear information regarding a particular entity, such as a fast-food restaurant, and be informed that the restaurant is open for business at that moment. It is believed by the inventors that consumers are more likely to frequent establishments that they are informed are open for business at the time the consumer sees and/or hears information regarding the establishment. In yet another embodiment, electronic billboard 118, such as provided on the side of a roadway, is provided such that a connection to information processor 102 is maintained to provide updated operating status information to passers-by. In this way, a consumer is informed whether an entity 300 is open or otherwise available at the moment the consumer sees the billboard, thereby increasing the likelihood that the consumer will patronize the entity 300.

Thus, as shown in the block diagram in FIG. 5, the present invention provides a plurality of ways and devices for users to be informed of a respective entity's 300 operating status.

The present invention is now further described with reference to three examples.

Two friends are watching a sports event on television at 10:30 p.m. in a living room. During an interlude, a television commercial is aired that describes a new restaurant in their neighborhood that delivers various food. Images of various menu items are shown along with audio descriptions. At the end of the commercial, a message is broadcast that says, “Come on down, or call us up, we're open right now!” The men pick up the telephone, call the number on the television screen and have two sandwiches delivered.

A man is running late and needs to drop off some clothes at his dry cleaner's store on his way home from work. The dry cleaner's normal business hours are over. Just before he gets in his car, the man calls his cellular telephone service provider's directory assistance and identifies the dry cleaner. The directory assistance automated response system states, “press number 1 to hear operating status of this entity.” The man presses number 1 and hears a message that the dry cleaner is currently open. The man arrives at the dry cleaner, drops off his clothes, and goes home. Further, the man's cellular telephone service provider charged the man only 20 cents for the operating status information, as opposed to the fee of $1.00 charged for the dry cleaner's telephone number.

One morning, a man opens his small retail store. He keys his personal code into the alarm panel to disable the security system, and a signal is transmitted to information processor 102 that indicates a change in the store's operating status. Database 108 is referenced by information processor 102, and the operating status is changed in the database from “closed” to “open.” The retail store's web site is automatically updated to indicate that the store is currently open. At the end of the day, the man closes his shop and keys in his alarm code to enable the security system. Information processor receives a signal that a change in operating status has occurred, database 108 is updated, and the store's web site is similarly updated to reflect that the store is closed.

Therefore, as represented by the above examples and as described herein, the present invention provides new, useful and convenient ways for entities to transmit operating status to information processor 102, and for requesting parties 302 to be informed of an entity's operating status. Other uses and products provided by the present invention will be apparent to those skilled in the art. For example, in an alternative embodiment a motion sensor that activates lights may be used to determine whether a restaurant, store or other entity is open or otherwise available or closed. In case of a retail store, in case lights remain off in a particular area for a predetermined period of time then a transmission may be sent to information processor that the entity is closed. In another case, for example, a restaurant uses a motion sensor in a particular area, such as the kitchen, to determine that the kitchen is closed and the restaurant is no longer serving. The present invention can thus be used to track physical activity and, thereafter, initiate a transmission to information processor 102 that represents whether the entity is open or closed.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A system for providing information representing operating statuses of a plurality of entities, the system comprising:
a database on at least one information processor that stores respective electronic entity information representing the plurality of entities, and stores respective electronic operating status information that represents a respective operating status for each of the respective entities;
a receiving module on the at least one information processor that is operable to receive over a communication network a plurality of first entity identifiers representing the respective entities, and further receives a plurality of status indicators that represent changes in the respective entities' operating status;
a tracking module on the at least one information processor that uses the status indicators to update the database with the electronic operating status information, and further to track current operating status for each of the plurality of entities; and
a transmitting module on the at least one information processor that is operable to retrieve from the database the electronic operating status information and the electronic entity information, and to transmit second entity identifiers representing the plurality of entities and respective electronic operating status information.

2. The system of claim 1, wherein the first entity identifiers and the second entity identifiers are the same.

3. The system of claim 1, wherein the first entity identifiers and the second entity identifiers are different.

4. The system of claim 1, wherein the transmitting module is operable to transmit the second entity identifiers and the respective electronic operating status information to a telephone directory assistance provider, an internet search engine, an internet web site, a voice mail system, a television advertiser, a radio advertiser, or a provider of electronic billboards.

5. The system of claim 4, wherein the telephone directory assistance provider charges a first fee for providing a telephone number, and a second fee for providing operating status information without the telephone number, wherein the second fee is lower than the first fee.

6. The system of claim 1, wherein the entities comprise a retail goods provider, a retail service provider, a professional service provider, a recreational facility, a financial institution, a fitness center, a sports arena, a government/municipal office, a theater, a shopping mall, a school office, a library, and/or a restaurant.

7. The system of claim 1, wherein the at least one information processor further provides an internet web site.

8. The system of claim 1, wherein the receiving module receives transmissions from a user terminal, a security system alarm panel, a fax machine, a login/logout device, and/or a telephone.

9. The system of claim 1, wherein the receiving module further comprises a telephone response system that is operable to receive telephone calls, and is further operable to receive touch-tone and/or voice commands.

10. The system of claim 1, wherein the status indicators received by the receiving module represent the operating status of the respective entities.

11. The system of claim 1, further comprising a motion detector that determines physical activity in a respective entity, and wherein the receiving module receives a transmission from the entity when the motion detector detects no activity for a predefined period of time.

12. A method for providing information representing operating statuses of a plurality of entities, the method comprising:
storing in a database respective electronic entity information representing the plurality of entities, and respective electronic operating status information that represents a respective operating status for each of the respective entities;
receiving over a communication network a plurality of first entity identifiers representing the respective entities, and a plurality of status indicators that represent changes in the respective entities' operating status;
using the status indicators to update the database with the electronic operating status information, and further tracking current operating status for each of the plurality of entities;
retrieving from the database the electronic operating status information and the electronic entity information; and
transmitting second entity identifiers representing the plurality of entities and respective electronic operating status information.

13. The method of claim 12, wherein the first entity identifiers and the second entity identifiers are the same.

14. The method of claim 12, wherein the first entity identifiers and the second entity identifiers are different.

15. The method of claim 12, wherein the step of transmitting further comprises transmitting the second entity identifiers and the respective electronic operating status information to a telephone directory assistance provider, an internet search engine, an internet web site, a voice mail system, a television advertiser, a radio advertiser, or a provider of electronic billboards.

16. The method of claim 15, wherein the telephone directory assistance provider charges a first fee for providing a telephone number, and a second fee for providing operating status information without the telephone number, wherein the second fee is lower than the first fee.

17. The method of claim 12, wherein the entities comprise a retail goods provider, a retail service provider, a professional service provider, a recreational facility, a financial institution, a fitness center, a sports arena, a government/municipal office, a theater, a shopping mall, a school office, a library, and/or a restaurant.

18. The method of claim 12, further providing an internet web site for entities to transmit information representing operating status, and requesting parties can determine the entities' respective operating status.

19. The method of claim 12, wherein the step of receiving further comprises receiving transmissions from a user terminal, a security system alarm panel, a fax machine, a login/logout device, and/or a telephone.

20. The method of claim 12, wherein the step of receiving further comprises a providing telephone response system that is operable to receive telephone calls, and is further operable to receive touch-tone and/or voice commands.

21. The method of claim 12, wherein the status indicators represent the operating status of the respective entities.

22. The method of claim 12, further comprising charging a fee to the plurality of entities.

23. The method of claim 12, further comprising storing in the database hours of operation of the respective entities.

24. The method of claim 12, further comprising determining by a motion detector whether physical activity occurs in an entity and transmitting a respective status indicator when the motion detector determines there is no physical activity.
